(19) United States
(12) Patent Application Publication
(10) Pub. No.: US 2003/0093330 A1
(43) Pub. Date: May 15, 2003

(54) Method for reordering custom-fitted apparel

(76) Inventors: Edward Pabst, Moraga, CA (US); Steven Carl Heard, Alameda, CA (US); Robert Gordon Ernest Holloway, Novato, CA (US); Jeffrey Aldredge Luhnow, Berkeley, CA (US)

Correspondence Address: Milbank, Tweed, Hadley & McCloy LLP, One Chase Manhattan Plaza, New York, NY, 10005-1413, US

(21) Appl. No.: 10/045,114

(22) Filed: Nov. 9, 2001

(51) Int. Cl. G06F 17/60

(52) U.S. Cl. 705/26

(57) ABSTRACT

It is consistent with the present invention to provide a method for allowing a user to reorder an article custom fitted to a human being comprising: providing the user access to a reordering interface through a user interface; allowing the user to customize the article, via said user interface, during a session with a customizing interface through the use of a visual aid; allowing the user to reorder the article, via said user interface. It is also consistent with the present invention to provide a system allowing a user to reorder an article custom fitted to a human being comprising: a reordering interface allowing the user to customize the article during a session with a customizing interface through the use of a visual aid and allowing the user to reorder the article.

### FIELD OF THE INVENTION

This invention relates to custom manufacturing of apparel and more particularly to a method for a reordering interface for an existing individual whose information has been captured from or about the individual for whom the garment is to be made. More specifically, this invention relates to the ability to reorder pieces of apparel and make selection adjustments and adjust features of a piece of apparel from a previously purchased/ordered custom or standard “off the shelf” garment.

### BACKGROUND OF THE INVENTION

Matching apparel consumers with garments that have all the desired properties, features, and fit is one of the biggest problems that apparel retailers face. The vast majority of apparel retailers struggle with managing the tradeoff between carrying a larger assortment of products and paying the high costs of carrying large amounts of inventory. A company choosing to offer a large assortment of products, product features or variations, and sizes quickly finds the costs of inventory, inventory handling costs, and infrastructure (e.g., distribution centers) become prohibitively large as the number of stock keeping units (SKUs) increases. On the other hand, a company with a more limited assortment will find that consumers either can't find the product or size they desire, or choose a product that often they are not satisfied with, and end up returning the garment. The combined cost associated with inventory and merchandise returns represents a significant portion of the overall costs for apparel retailers, especially those who sell through direct channels such as the Internet, TV, or mail. The lost revenue opportunity for apparel retailers of all types, including store based retailers, associated with not having the correct size or product in stock can easily make the difference between a struggling and successful company.

Those consumers who find an apparel product in their size are often times settling for the best of the limited options available, rather than getting a garment that fits them properly. A survey cited in U.S. Pat. No. 5,548,519, issued to Sung K. Park on Aug. 20, 1996, for an apparatus and method for custom apparel manufacturing, found that the percentage of the population that is correctly fitted by an available standard-sized article of clothing without any alteration is only two percent.

There are two fundamentally different approaches to helping apparel consumers find garments that best meet their needs. The first involves gathering or capturing information about a consumer and using that information to recommend particular brands, products, and sizes that are likely to fit or match a consumer's tastes. The benefit of this approach is that it theoretically increases the probability that a consumer will find the best available standard product. The drawback is that this approach doesn't solve the assortment-inventory tradeoff described above, nor does it resolve the issue of failure to achieve proper fit without further garment alteration.

The second approach involves custom making of apparel garments for consumers after preference and sizing information has been captured. The apparatus and method disclosed in U.S. Pat. No. 5,548,519 is an example of this approach. This approach involves having consumers try on several products of predetermined dimensions until the consumer approves the fit and purchases the garment. At that point, the information captured during the try-on session is reported to a manufacturing system that begins the process of making the garment. Another approach, described in U.S. Pat. No. 5,956,525, issued to Jacob Minsky on Sep. 21, 1999, for a method of measuring body measurements for custom apparel manufacturing, involves the use of multiple cameras in a specially designed room, capturing height and width data about a consumer. These data are then used to manufacture the clothing.

These approaches do provide the manufacturing system with information that is useful in producing a custom garment, and will likely result in a better fitting garment than the standard sizes. Since the garments are made after the consumer order has been completed, there is less of a need for retailers to carry large amounts of finished-goods inventory. The downside of these approaches is that they require substantial involvement and time from the consumer. The majority of consumers find that shopping for apparel is not a particularly desirable activity, but rather a necessary evil. Any product that requires more involvement and more time from consumers will find limited potential in today's environment where an increasingly large number of household or personal needs can be met from a computer, a laptop, a PDA, or even a cell phone.

Initially, at the time at which a first purchase is made, a consumer is asked a series of questions about themselves (or the person for whom they are purchasing the item), their preferences, desired features, and other product choices regarding the item that is being considered. The questions are asked in such a way that consumers can quickly provide the necessary information in order to complete the ordering process, without requiring the assistance of a store clerk or tailor. The information that is captured from or on behalf of the person for whom the item is intended serves as inputs to a set of model formulas that calculates other pieces of information needed for developing product specifications and production instructions for the manufacturing of a custom apparel product, but not provided directly by the consumer. SEE U.S. patent application Ser. No. 09/909,930, filed on Jul. 20, 2001, and incorporated herein by reference in its entirety.

A retailer's ability to retain a consumer for subsequent purchases is an important driver of business performance. Typically, the customer acquisition cost to a retailer is higher than the profit margin generated by the first basket of goods purchased by a consumer, so the retailer must rely on repeat visits and purchases over time in order to profit from an individual consumer When a consumer has confidence that the apparel available at a particular retailer fits them correctly, they are likely to make replenishment purchases, as well as purchase more products by selecting additional colors, styles, fashions, and product features For example, a consumer might like the fit of the piece of apparel but desire the garment to be a different color or be composed from a different fabric. A consumer could like the style and the feel of the piece of apparel but would like slight adjustments in the actual dimensions of the garment to suit the individual desires of the consumer. For example, a consumer might wish to wear the piece of apparel tighter or looser than the normal fit of the garment. A consumer might wish to reorder a pair of pants but would like to change the rise or the seat of the pants to fit individual likes and wants.

### OBJECTS OF THE INVENTION

It is an object of the present invention to provide a system and method for a reordering interface which allows existing consumers of an apparel retailer or brand to adjust a previously purchased piece of apparel to specifications that meet the consumer's desired wants and needs. The information can be communicated remotely over the phone, using the Internet, interactive television, via mail, or through any other communication device that is used for electronic commerce such as web-enabled phones or personal digital assistants (PDAs). This information can also be communicated directly to a retailer's agent, a kiosk, or any other information capture tool in a store environment. An object of the invention is to create a system that is easy to utilize and entices a customer to return to the reordering interface and make future purchases from the retailer.

It is an object of the invention to provide a reordering interface to allow a consumer to reorder pieces of apparel they desire but to make adjustments to the reordered garments to meet individual needs. During a previous purchase, information may be generated regarding the article of clothing. Basic information regarding the ordered article's type, style, fabric, color, size, and garment dimensions may be stored for later use.

It is an object of the present invention to provide a method of user interfacing to reorder products that can be customized based on an individual person's body shape, lifestyle attributes, and product preferences in order to allow customers to quickly, easily, and conveniently order custom apparel.

Another object of the present invention is to use a system and method of determining necessary product specifications such as garment dimensions based upon both consumer-provided and model-derived human body dimensions that provides retailers and manufacturers of these products with all the necessary dimensions and other specifications required to produce a custom apparel product. Yet another object of the present invention is to provide a method for adjusting calculated garment dimensions on the basis of consumer-selected garment fit preferences.

A further object of the present invention is to provide a method of shopping for products that can be customized based on an individual person's body shape and product preferences as a marketing and sales tool for retailers and manufacturers to provide custom apparel for consumers.

A still further object of the invention is to provide an adjustment capability for a purchaser who has originally purchased a garment that fits very poorly, poorly, relatively well, or quite well.

Another still further object of the invention is to provide the capacity to ask a consumer to request an adjustment to a garment dimension that the consumer would not be able to specify at the time of purchasing an initial garment.

These and other features of the present invention are described in more detail in the following detailed description. The scope of the invention, however, is limited only by the claims appended hereto.

### SUMMARY OF THE INVENTION

It is consistent with the present invention to provide a method for allowing a user to reorder an article fitted to a human being comprising: providing the user access to a reordering interface through a user interface; allowing the user to customize the article, via said user interface, during a session with a customizing interface through the use of a visual aid; allowing the user to reorder the article, via said user interface. It is also consistent with the present invention to provide a system allowing a user to reorder an article fitted to a human being comprising: a reordering interface allowing the user to customize the article during a session with a customizing interface through the use of a visual aid and allowing the user to reorder the article.

### DETAILED DESCRIPTION OF THE PREFERRED AND OTHER EMBODIMENTS

There are numerous ways an apparel retailer can capture necessary information from a consumer interested in purchasing apparel, both remotely and in-store. Reordering information for apparel can be recaptured in a similar manner. Remotely, the interested consumer can access a retailer's web site through any number of user interfaces such as a computer, a PDA, a web enabled phone, interactive television, or any other electronic medium used to access the Internet. Also remotely, the interested consumer can call a retailer's customer service or ordering center, or they could send a fax or use any form of mail. In a store environment, the interested consumer could either provide the information directly to an employee of the retailer, or use any self-service device in the store such as a kiosk, Internet terminal or customer service telephone.

In a preferred embodiment, the potential consumer would log on to the retailer's web site wherein the consumer has previously purchased standard and/or customized items from that retailer. This web site may have a combination of standard and custom products, or may offer exclusively custom made products (a pair of pants, a pair of jeans, a sweater, a skirt, a dress, a shirt, a blouse, a vest, a jacket, a coat, a pair of knickers, a pair of leggings, a jersey, a pair of shorts, a leotard, a pair of underwear, a hat, a cap, and a swimming or bathing suit). A potential customer may log on to the reordering interface by providing admittance security information to allow the reordering interface access to previously purchased garments by the user for reordering in the first selection interface. The typical security information to be used would be a logon id and a password.

A customer order history of all previous pieces of apparel purchased by the user may be listed for the consumer. The user then may begin to make choices about reordering the product the consumer desires from the purchasing history of the consumer. The customer order history would detail information concerning previously purchased items. In the case of pants, the user would be provided with detailed information regarding the item number, the product name, the fabric, the color, the style, as well as the selected cuffs, pleats, and the type of fly (zipper or button) that was ordered in a previous purchase. These are just some of the feature and style choices that could be available.

After logging on an informational banner may be displayed informing the potential customer of their location in the reordering interface. The information banner may detail the steps during the reordering process that the consumer has completed and/or needs to complete. The list could include an order history indicator, a sizing indicator, a design indicator, and sign-off mechanism to allow the user to move between the selection interfaces. The information banner may appear on all of the selection interfaces providing ease of movement for the user to shift from one selection interface to another.

Once the potential consumer has selected a piece of apparel to reorder, the potential customer can view the selected garment for reordering and customize the features of the reordered piece of garment to individual tastes of the potential customer in the second selection interface. By being able to adjust features and sizes the customer may enjoy a greater fit and feel to the article delivering a higher level of satisfaction to the user from the purchase of the article. A satisfied customer may return to the reordering interface to purchase further items from the reordering interface. A customer may be more likely to reorder from an interface if provided with excellent services and an individual feel to the first order and subsequent reorder purchases. Satisfied customers may be more likely to reorder than unsatisfied ones. Reorders may mean the retailer will realize higher sales. In addition, the satisfied customer may inform other potential consumers of the reorder customer's satisfaction with the reorder interface. The new potential customers may interact with the interface, purchase articles from the retailer, and then be able to make adjustments via the reordering interface. This may also generate additional sales for the retailer.

In the second selection interface, a detailed description of the previously ordered item may appear to remind the potential customer of the style and features of the previous purchase. The detailed description may include such aspects as type of garment, color, type of fabric, and individual customized features for each garment like cuffs for pants or button down collar for shirts. In the preferred embodiment, the reordered garment may be customized by selecting a fabric type and/or a color type that are available for the selected garment. The potential customer may also customize style features. In the most preferred embodiment, the potential customer could select whether the pants should have a flat front, forward pleats, or reverse pleats. In the preferred embodiment the potential customer can select whether pants should have cuffs or not. All of the customizing adjustments may be limited by the type of reordered article selected by the user. For example, if a user decides on a type of fabric and a color that is unavailable for that garment, the user may be restricted from selecting the unavailable color.

A “Help Area” may provide a potential customer with further information describing any of the features of the piece of apparel that are unclear to the potential customer. For example, if a user clicks on the help mechanism for fabric type, a breakdown of the fabric's materials such as whether the fabric is composed of 100% cotton or combination of materials maybe displayed to the user.

With the third selection interface, the user may customize the size of the reordered piece of apparel. A visual design featuring the type of garment selected may aid the potential customer in customizing the garment's dimensions to fit a need of the customer. In the preferred embodiment, the visual design may display a pair of pants and show the various customizing adjustments that can be made to a pair of pants. The adjustment display provided for the pair of pants may refer to how alterations will occur on the article of apparel that is to be reordered. Each adjustment may correspond to an adjustment on the reorder article. For example, a tightening in the waist of a pair of pants by one-inch on the visual display may relate to a one-inch reduction on the actual pair of pants to be reordered. In the preferred embodiment, the visual design may display the waist size, the rise of the pants, the seat of the pants, length of the pants, and the leg opening. For a long-sleeved shirt, the visual design may display the neck size, length of sleeves, size of the arm openings, length of the body of the shirt, and width of the shirt. Size adjustment features may be limited by the style of the garment selected. All selected feature changes may be stored and the reordered piece of apparel may be adjusted according to the selections by the customer.

In the third selection interface a visual design may aid the potential customer to make sizing adjustments to the piece of apparel. In the preferred embodiment the visual aid design may be a ruler. The ruler may be centered at zero and the customer may be allowed to adjust the selected size to tighten or loosen, in predetermined size increments, the piece of apparel depending on the potential customer's desires. In the preferred embodiment, the potential customer may adjust a pair of pants' waist size, seat size, pants rise, pants length, and the leg openings in selected increments by the use of a visual aid such as a slider, ruler, or another type of depiction of numerical increment. The visual aid may allow the customer to adjust a feature and the adjustment to the feature may correspond to adjustments to the actual article for a custom fitted article of clothing. The predetermined size increments may have maximum tightening and loosening limits because if the potential customer exceeds those limits it may be more efficient for the potential customer to order a new article of apparel instead of reordering the same garment. If an adjustment on the visual adjustment display is shortened or tightened a “minus” sign may appear in the size increment to denote a tightening or shortening of the article of apparel. Positive numbers may relate to a loosening or lengthening of the article at that visual adjustment. For example, waist adjustments may be limited by plus or minus three inches. Any further adjustments may require a user to order a new item. A potential customer could access a help area to further describe or define any of features of the piece of apparel that are unclear to the potential customer. A help aid may provide assistance to the user to understand how adjustments can be determined and how adjustments will affect the wear of the article of clothing. The help aid for the rise of the pair of pants may detail how a greater rise will affect how a user wears the pants; either lower or higher on the waist depending on the adjustments made.

In a preferred embodiment the leg opening feature may not be adjusted by a ruler but by a display of whether the user would like to widen or narrow the pants. The narrowing or widening adjustments could be either a small adjustment or a large adjustment. The alterations in the leg opening would correspond to actual changes in the reorder article.

The information that is collected for sizing may be information that most apparel consumers know about themselves, and that can be used to either (1) directly determine desired measurements for the design of the garment pattern, or (2) estimate, either alone or in conjunction with other pieces of information, other necessary measurements for the design of the garment pattern. Consumers may also be asked to make assessments of themselves and their body shape, as well as to take simple measurements of certain of their body dimensions if the user's body shape has altered since the last order or they wish to make slight variations for comfort.

Once the reorder information is collected from the potential consumer, the adjustments made in the first, second, and third selection interfaces may be combined with information captured and/or generated during the previous order purchase to create the customized reordered article for the fourth selection interface.

In the preferred embodiment, a summary of the order including the adjustments to the reordered article may be displayed in the fourth selection interface. The fourth selection interface may provide a recap of the reorder with the customizations completed by the user. In the preferred embodiment, all of the features selected and stored may be provided to the user to allow the user to make alterations to the adjustment. In the preferred embodiment the user may be able to view how the size adjustments may affect the reorder article. For example, in a pair of pants if the potential consumer had adjusted the waist to be looser by one inch, the size recap may say “Your pant waist will be loosened by 1.” Tightening, shortening, and lengthening adjustments may be displayed in a similar manner. In the preferred embodiment, if any adjustments to size are made a distinguishing marker may be provided to alert the user to the adjustments made. If the user did not make any adjustments to the size then no distinguishing marker may be provided by the fourth selection interface. In the preferred embodiment, the fourth selection interface may allow a user to purchase the reorder article or return to other selection interfaces to alter any adjustments that had been made to the reorder article. The fourth selection interface may allow the user to correct errors made by the user. The fourth interface may provide a higher level of satisfaction to the user to ensure the user receives a suitable reorder article.

A person of ordinary skill in the art would recognize that the preferred embodiments are not limited to specific articles fitted for a human being and the reordering interface would encompass, but not be limited by, all pieces of apparel listed and adjustments made to the apparel, as well as various other articles of manufacture that must be fitted to a human being.

We claim:

1. A method for allowing a user to reorder an article fitted to a human being comprising:
providing the user access to a reordering interface through a user interface;
allowing the user to customize the article, via said user interface, during a session with a customizing interface through the use of a visual aid;
allowing the user to reorder the article, via said user interface.

2. The method of claim 1, wherein said customizing interface allows a user to customize the article, via said visual aid, to satisfy the needs of said user.

3. The method of claim 1, wherein the article is selected from the group consisting of a pair of pants, a pair of jeans, a sweater, a skirt, a dress, a shirt, a blouse, a vest, a jacket, a coat, a pair of knickers, a pair of leggings, a jersey, a pair of shorts, a leotard, a pair of underwear, a hat, a cap, and a swimming or bathing suit.

4. The method of claim 1, wherein the article is a pair of pants.

5. The method of claim 1, wherein said visual aid allows the user to adjust the article in an incremental amount.

6. The method of claim 5, wherein said visual aid comprises a slider.

7. The method of claim 5, wherein said visual aid comprises a ruler.

8. The method of claim 5, wherein said visual aid can be altered by a numerical increment.

9. The method of claim 2, wherein said customizing interface provides one or more selection interfaces.

10. The method of claim 9, wherein said customizing interface comprises a first selection interface allowing the user to reorder an article selected from a customer order history;
a second selection interface allowing the user to customize a feature of the reorder article;
a third selection interface allowing the user to adjust an article dimension of the reorder article; and
a fourth selection interface providing the user a features summarization and an order confirmation option.

11. The method of claim 9, wherein one of said one or more selection interfaces provides a list of previous articles purchased by the user.

12. The method of claim 9, wherein one of said one or more selection interfaces comprises a customer order history, and wherein said customer order history comprises an item number, a product name, a color, a chosen features list, an order date, a status, and a reorder selection mechanism.

13. The method of claim 9, wherein one of said one or more selection interfaces provides a features inventory that allows the user to customize the article.

14. The method of claim 13, wherein said features inventory comprises fabric selection, color selection, and article style.

15. The method of claim 14, wherein said article style comprises a front panel style for the article.

16. The method of claim 15, wherein said article style comprises a cuff style for the article.

17. The method of claim 9, wherein one of said one or more selection interfaces comprises a visual aid depicting a size dimension.

18. The method of claim 17, wherein said size dimension comprises waist.

19. The method of claim 17, wherein said size dimension comprises rise.

20. The method of claim 17, wherein said size dimension comprises seat.

21. The method of claim 17, wherein said size dimension comprises length.

22. The method of claim 17, wherein said size dimension comprises leg-opening.

23. The method of claim 9, wherein one of said one or more selection interfaces comprises a reorder recap of adjustments to the article made by the user during said session.

24. The method of claim 23, wherein said reorder recap comprises a list of customizations to the article.

25. The method of claim 24, wherein said list comprises fabric, color, article style, and size dimensions.

26. The method of claim 23, wherein said reorder recap comprises a distinguishing mechanism to alert the user to adjustments made to said size dimensions.

27. The method of claim 23, further comprising an ordering option.

28. The method of claim 23, further comprising an adjustment option allowing the user to return to any one of said one or more selection interfaces.

29. A system allowing a user to reorder an article fitted to a human being comprising:
a reordering interface allowing the user to customize the article during a session with a customizing interface through the use of a visual aid and allowing the user to reorder the article.

30. The system of claim 29, wherein said customizing interface allows the user to customize the article, via said visual aid, to satisfy the user's needs.

31. The system of claim 29, wherein the article is selected from the group consisting of a pair of pants, a pair of jeans, a sweater, a skirt, a dress, a shirt, a blouse, a vest, a jacket, a coat, a pair of knickers, a pair of leggings, a jersey, a pair of shorts, a leotard, a pair of underwear, a hat, a cap, and a swimming or bathing suit.

32. The system of claim 29, wherein the article is a pair of pants.

33. The system of claim 29, wherein said visual aid allows the user to adjust the article in an incremental amount.

34. The system of claim 33, wherein said visual aid comprises a slider.

35. The system of claim 33, wherein said visual aid comprises a ruler.

36. The system of claim 33, wherein said visual aid can be altered by a numerical increment.

37. The system of claim 29, wherein said customizing interface provides one or more selection interfaces.

38. The system of claim 37, wherein said customizing interface comprises a first selection interface allowing the user to reorder an article from a customer order history;
a second selection interface allowing the user to customize a feature of the reorder article;
a third selection interface allowing the user to adjust an article dimension of the reorder article; and
a fourth selection interface providing the user a features summarization and an order confirmation option.

39. The system of claim 37, wherein one of said one or more selection interfaces provides a list of previous articles purchased by the user.

40. The system of claim 37, wherein one of said one or more selection interfaces comprises a customer order history, and wherein said customer order history comprises an item number, a product name, a color, a chosen features list, an order date, a status, and a reorder selection mechanism.

41. The system of claim 37, wherein one of said selection interfaces comprises a features inventory that allows the user to customize the article.

42. The system of claim 41, wherein said features inventory comprises a fabric selection, a color selection, and an article style.

43. The system of claim 42, wherein said article style comprises a front panel style.

44. The system of claim 42, wherein said article style comprises a cuff style.

45. The system of claim 41, wherein said one of said selection interfaces comprises a visual aid depicting a size dimension.

46. The system of claim 45, wherein said size dimension comprises waist.

47. The system of claim 45, wherein said size dimension comprises rise.

48. The system of claim 45, wherein said size dimension comprises seat.

49. The system of claim 45, wherein said size dimension comprises length.

50. The system of claim 45, wherein said size dimension comprises leg-opening.

51. The system of claim 37, wherein one of said selection interfaces comprises a reorder recap of adjustments to the article made by the user during said session.

52. The system of claim 51, wherein said reorder recap comprises a list of customizations to the article.

53. The system of claim 52, wherein said list comprises fabric, color, article style, and size dimensions.

54. The system of claim 52, wherein said reorder recap comprises a distinguishing mechanism to alert the user to adjustments made to said size dimensions.

55. The system of claim 52, further comprising an ordering option.

56. The system of claim 52, further comprising an adjustment option allowing the user to return to any one of said one or more selection interfaces.

57. The method of claim 17 wherein said size dimension comprises an article dimension.

58. The method of claim 17 wherein said size dimension comprises a human body dimension.

59. The system of claim 45 wherein said size dimension comprises an article dimension.

60. The system of claim 45 wherein said size dimension comprises a human body dimension.
